(19) United States
(12) Patent Application Publication
(10) Pub. No.: US 2013/0194301 A1
(43) Pub. Date: Aug. 1, 2013

(54) SYSTEM AND METHOD FOR SECURELY TRANSMITING SENSITIVE INFORMATION

(71) Applicant: Burn Note, Inc., Brooklyn, NY (US)

(72) Inventors: JACOB ROBBINS, BROOKLYN, NY (US); MOSES S. ROBBINS, TYBEE ISLAND, GA (US)

(73) Assignee: BURN NOTE, INC., BROOKLYN, NY (US)

(21) Appl. No.: 13/753,513

(22) Filed: Jan. 29, 2013

Related U.S. Application Data
(60) Provisional application No. 61/592,584, filed on Jan. 30, 2012.

(51) Int. Cl. G06F 21/60

(52) U.S. Cl. CPC G06F 21/60
USPC 345/629

(57) ABSTRACT

A system and method for securely transmitting information over a communications network comprises receiving a message notification that a recipient has a message on a recipient's client device from a processor based server upon receipt of the message from a sender's client device. The message from the sender's client device is stored in a storage device by the server. The recipient accesses the server to view the message using the recipient's client device. The message is rendered and displayed on the screen by the recipient's client device in accordance with a display method selected by the sender of the message to present only a portion of the message at any given time to the recipient. The prevents the message from being recorded or captured.

### RELATED APPLICATION

This application claims the benefit of U.S. Provisional Application No. 61/592,584 filed Jan. 30, 2012, which is incorporated herein by reference in its entirety.

### BACKGROUND OF THE INVENTION

The invention relates to transmitting sensitive messages, more particularly to preventing the contents of sensitive messages from being digitally recorded during viewing or being viewed by people besides the intended recipient.

When sending messages with sensitive information it is the sender's goal that each message goes only to the intended recipient and is not spread to a wider audience. Digital technologies make this difficult by allowing for very easy copying. The sender must worry both about the recipient intentionally redistributing the information (e.g. by taking steps to make a copy or retransmitting the original message) and also about the recipient unintentionally redistributing the information by allowing access to it (e.g. by another person looking over the recipient's shoulder while they are viewing it or gaining access to the system where it is stored at a later time). The ability of the sender to control their messages is limited by the fact that they are usually not physically present with the recipient when the message is viewed.

The current state of the art involves technology which attempts to limit the recipient's use of certain device features to make copies of a document's contents, for example, by disabling the built-in print, copy and paste, or screenshot functions of the device. The current state of the art also involves technology which limits the time in which a recipient may view the message contents based on time since sending, time since first view, number of views or other factors. These methods do not block taking a photo of the contents of the message, or another person viewing the message over the recipient's shoulder. They also do not block taking a screenshot of a message on devices which do not facilitate disabling the screenshot feature. Compared to the current state of the art, our invention adds additional protection against ways in which message contents are transmitted beyond the direct recipient.

Accordingly, the claimed invention proceeds upon the desirability of providing method and system for securely transmitting information over the communications network that prevents or minimizes recording or capture of sender's messages.

### OBJECTS AND SUMMARY OF THE INVENTION

An object of the present invention is to provide a system and method for preventing the contents of a message from being digitally recorded by the recipient.

Another object of the present invention is to provide a system and method for preventing the contents of a message from being read by other people besides the recipient who are physically proximate to the recipient at the time the message is received.

In accordance with an exemplary embodiment of the claimed invention, the system comprises an on-line messaging system where the recipient must actively hold down the mouse button or their finger to view the message contents and can only view a limited part of the message contents at any one time.

In accordance with an exemplary embodiment of the claimed invention, a method for securely transmitting information over a communications network comprises receiving a message notification that a recipient has a message on a recipient's client device from a processor based server upon receipt of the message from a sender's client device over the communications network. The message from the sender's client device is stored in a storage device by the server. The recipient accesses the server to view the message using the recipient's client device. The message is rendered and displayed on the screen by the recipient's client device in accordance with a display method selected by the sender of the message to present only a portion of the message at any given time to the recipient. The prevents the message from being recorded or captured.

In accordance with an exemplary embodiment of the claimed invention, the aforesaid method further comprises retrieving from the server, the message with a message cover to entirely obscure the message when displayed by the recipient client device. The message cover is displayed on the screen of the recipient's client device which entirely obscures the message. A hole having a predetermined shape and size in the message cover is displayed, within proximity of an area of the screen tapped or clicked by the recipient, to reveal the portion of the message underneath the hole. This prevents others in proximity of the recipient from viewing the message displayed on the recipient's client device.

In accordance with an exemplary embodiment of the claimed invention, the aforesaid method further comprises moving the hole to reveal a different portion of the message by clicking or tapping a different area of the screen by the recipient.

In accordance with an exemplary embodiment of the claimed invention, the aforesaid method further comprises closing the hole to entirely obscure the message when the area of the screen tapped or clicked is released by the recipient.

In accordance with an exemplary embodiment of the claimed invention, the aforesaid method further comprises closing the hole to entirely obscure the message after predetermined period of time.

In accordance with an exemplary embodiment of the claimed invention, the aforesaid method further comprises converting the message into a set of partial images by the server when the recipient's device access the server to view the message. Each partial image contains a portion of the message. A movie representative of the message is generated by the server using the partial images as an individual movie frames. The partial images and the movie is stored by the server in the storage device. The movie representative of the message is transmitted to the recipient's client device by the server. Each individual frame of the movie represents a portion of the message. Accordingly only a portion of the message at any given time is displayed on the recipient's client device to the recipient. This prevent the message from being recorded or captured.

In accordance with an exemplary embodiment of the claimed invention, the aforesaid method further comprises converting the message into an image of the message and generating the set of partial image by removing a series of horizontal or vertical strips from the image.

In accordance with an exemplary embodiment of the claimed invention, the aforesaid method further comprises receiving a code to view the message on the server by the recipient using the recipient's client device.

In accordance with an exemplary embodiment of the claimed invention, the aforesaid method further comprises transmitting a delete notification to delete the message to the server when the message is displayed by the recipient's client device. The message is also deleted from the recipient's client device after a predetermined period of time.

In accordance with an exemplary embodiment of the claimed invention, the aforesaid method further comprises deleting the message from the server after a predetermined time. The delete notification is transmitted to all client devices with a copy of the message by the server.

In accordance with an exemplary embodiment of the claimed invention, the system for securely transmitting information over a communications network comprises a processor based server and a plurality of processor based client devices for sending and receiving messages over the communications network. Each client device is network enabled, associated with a user and comprises a screen to compose and display messages. The processor based server receives and stores messages from the plurality of client devices in a storage device. The server transmits a message notification to a client device associated with a recipient of each message. The recipient's client device accesses the server to view the message. The recipient's client device renders and displays the message in accordance with a display method selected by a sender of the message so as to present only a portion of the message at any given time on its display the recipient. This prevents the message from being recorded or captured.

In accordance with an exemplary embodiment of the claimed invention, the aforesaid recipient's client device retrieves the message with a message cover and displays the message with the message cover on its screen. The message cover entirely obscures the message from being viewed by the recipient. The recipient's client device displays a hole having a predetermined shape and size in the message cover, within proximity of an area of the screen tapped or clicked by the recipient, to reveal the portion of the message underneath the hole. This prevents others in proximity of the recipient from viewing the message displayed on the screen.

In accordance with an exemplary embodiment of the claimed invention, the aforesaid the recipient's client device moves the hole to reveal a different portion of the message in response to a different area of the screen tapped or clicked by the recipient.

In accordance with an exemplary embodiment of the claimed invention, the aforesaid recipient's client device closes the hole to entirely obscure the message when the area of the screen tapped or clicked is released by the recipient.

In accordance with an exemplary embodiment of the claimed invention, the aforesaid recipient's client device closes the hole to entirely obscure the message after predetermined period of time.

In accordance with an exemplary embodiment of the claimed invention, the aforesaid server converts the message into a set of partial images when the recipient's client device access the server to view the message. Each partial image contains a portion of the message. The server generates a movie representative of the message by using the partial images as an individual movie frames. The partial images and the movie are stored in the storage device. The server transmits the movie representative of the message to the recipient's client device. Each individual frame representing a portion of the message. The recipient's client device displays each individual frame of the movie on the screen so that only a portion of the message is presented at any given time to the recipient to prevent recording or capture of the message.

In accordance with an exemplary embodiment of the claimed invention, a non-transitory computer readable medium comprising computer executable code for securely transmitting information over a communications network. The computer executable code comprises instructions receiving a message notification that a recipient has a message on a recipient's client device from a processor based server upon receipt of the message from a sender's client device over the communications network. The sender's message is stored in a storage device by the server. The recipient using the recipient's client device accesses the server to view the message over the communications network. The message is rendered and displayed on the recipient's client device in accordance with a display method selected by a sender of the message to present only a portion of the message at any given time to the recipient, thereby preventing recording or capture of the message.

In accordance with an exemplary embodiment of the claimed invention, the computer executable code further comprises instructions for retrieving, from the server, the message with a message cover to entirely obscure the message when displayed by the recipient client device. The message cover is displayed on a screen of the recipient's client device which entirely obscures the message. A hole having a predetermined shape and size in the message cover is displayed, within proximity of an area of the screen tapped or clicked by the recipient, to reveal the portion of the message underneath the hole. The prevents others in proximity of the recipient from viewing the message displayed on the recipient's client device.

In accordance with an exemplary embodiment of the claimed invention, the executable code further comprises instructions for converting the message into a set of partial images by the server when the recipient's client device access the server to view the message. Each partial image contains a portion of the message. A movie representative of the message is generated by the server using the partial images as an individual movie frames. The partial images and the movie is stored in the storage device by the server. The movie representative of the message is transmitted to the recipient's client device by the server. Each individual frame of the movie represents a portion of the message. Accordingly only a portion of the message at any given time is displayed on the recipient's client device to the recipient. This prevent the message from being recorded or captured.

In accordance with exemplary embodiment of the claimed invention, the computer executable code further comprises instructions converting the message into an image of the message and generating the set of partial image by removing a series of horizontal or vertical strips from the image.

Various other objects, advantages and features of the present invention will become readily apparent from the ensuing detailed description, and the novel features will be particularly pointed out in the appended claims.

### BRIEF DESCRIPTION OF THE DRAWINGS

The following detailed description, given by way of example, and not intended to limit the present invention solely thereto, will best be understood in conjunction with the accompanying drawings in which:

FIG. 1 is a block diagram of the system in accordance with an exemplary embodiment of the claimed invention;

FIG. 2A is a block diagram of a client device in accordance with an exemplary embodiment of the claimed invention;

FIG. 2B is a block diagram of a server in accordance with an exemplary embodiment of the claimed invention;

FIG. 3A is a block diagram of the message composition screen with option section closed in accordance with an exemplary embodiment of the claimed invention;

FIG. 3B is a block diagram of the message composition screen with option section open in accordance with an exemplary embodiment of the claimed invention;

FIGS. 4A-4B are block diagrams of the message delivery screen with and without the confirmation dialog in accordance with an exemplary embodiment of the claimed invention;

FIG. 5A is a block diagram of the message received cover page in accordance with an exemplary embodiment of the claimed invention;

FIG. 5B is a block diagram of the message received cover page with a password option in accordance with an exemplary embodiment of the claimed invention;

FIG. 5C is a block diagram of the message received cover page for deleted message in accordance with an exemplary embodiment of the claimed invention;

FIGS. 6A-D are illustrations showing the components of the spotlight method for viewing message contents in accordance with an exemplary embodiment of the claimed invention; and

FIGS. 7A-D are illustrations showing exemplary frames of the video method for viewing message contents in accordance with an exemplary embodiment of the claimed invention.

### DETAILED DESCRIPTION OF THE EMBODIMENTS

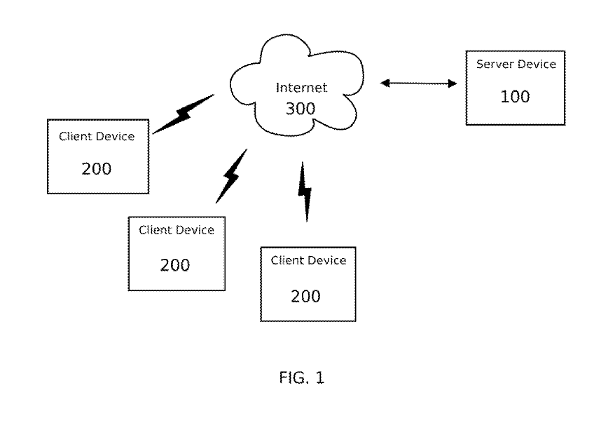

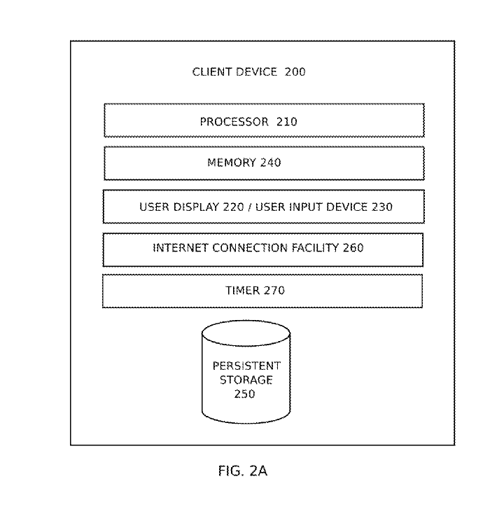

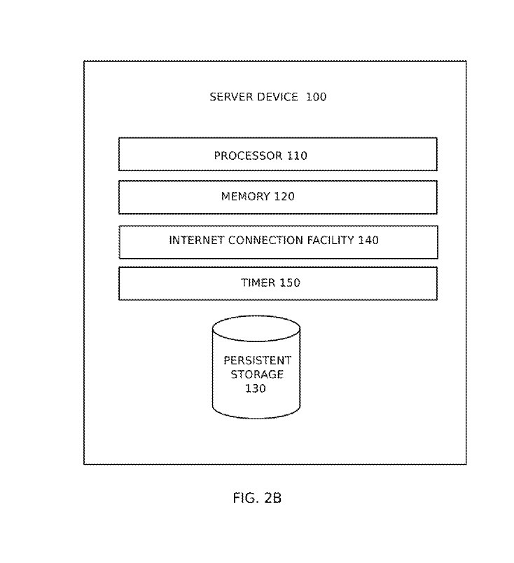

As shown in FIG. 1, at the system level, the claimed invention comprises one or more web-enabled processor based client devices 200, one or more processor based servers 100, and a communications network 300 (e.g., Internet). In accordance with an exemplary embodiment of the claimed invention, as shown in FIG. 2A, each client device 200 comprises a processor or client processor 210, a display or screen 220, an input device 230 (which can be the same as the display 220 in the case of touch screens), a memory 240, a storage device 250 (preferably, a persistent storage, e.g., hard drive), an Internet connection facility 260 to connect to the communications network 300, which can be wired and/or wireless connection device, and an optional message countdown/destruction timer 270.

In accordance with an exemplary embodiment of the claimed invention, the server 100 comprise a processor or server processor 110, a memory 120, a storage device 130 (preferably a persistent storage, e.g., hard disk, database, etc.), an Internet connection facility 140 to connect to the communications network 300, and optional timer 150.

The network enabled client device 200 includes but is not limited to a computer system, a personal computer, a laptop, a notebook, a netbook, a tablet or tablet like device, an IPad® (IPAD is a registered trademark of Apple Inc.) or IPad like device, a cell phone, a smart phone, a personal digital assistant (PDA), a mobile device, or a television, or any such device having a screen connected to the communications network 300 and the like.

The communications network 300 can be any type of electronic transmission medium, for example, including but not limited to the following networks: a telecommunications network, a wireless network, a virtual private network, a public internet, a private internet, a secure internet, a private network, a public network, a value-added network, an intranet, a wireless gateway, or the like. In addition, the connectivity to the communications network 300 may be via, for example, by cellular transmission, Ethernet, Token Ring, Fiber Distributed Datalink Interface, Asynchronous Transfer Mode, Wireless Application Protocol, or any other form of network connectivity.

Moreover, in accordance with an embodiment of the claimed invention, the computer-based methods for implementing the claimed invention are implemented using processor-executable instructions for directing operation of a device or devices under processor control, the processor-executable instructions can be stored on a tangible computer-readable medium, such as but not limited to a disk, CD, DVD, flash memory, portable storage or the like. The processor-executable instructions can be accessed from a service provider's website or stored as a set of downloadable processor-executable instructions, for example or downloading and installation from an Internet location, e.g. the server 100 or another web server (not shown).

In accordance with an exemplary embodiment of the claimed invention, the inventive method for securely transmitting sensitive information is now described herein from the perspective of two users: a message sender (i.e., sender) and a message recipient (i.e., receiver). The sender generates a message using her client device 200 (hereinafter the “sender's client device 200). After the message has been created a notification is sent to the recipient's client device 200 over the communications network. Depending on the embodiment employed by the system, the notification can be sent by the sender's client device 200 or the server 100.

In accordance with an exemplary embodiment of the claimed invention, the message contents are stored on the server 100, such as the storage 130, until the recipient's client device 200 requests or retrieves them from the server 100. Alternatively, the sender's client device 200 can sent the message contents directly to the recipient's client device 200, thereby bypassing the server 100. In such embodiment, the server 100 is only utilized to route the message and/or the notification from the sender's client device 200 to the recipient's client device 200.

The recipient's client device 200 displays the message contents to the recipient user utilizing various novel methods to minimize or prevent dissemination of the message contents. In accordance with an exemplary embodiment of the claimed invention, two methods for securely transmitting information to protect against the dissemination of the message contents are described herein, specifically the “spotlight display method” and the “video display method”.

In accordance with an exemplary embodiment of the claimed invention, all the devices (the sender's client device 200, the recipient's client device 200 and the server 100) delete the message contents after the recipient user has viewed the message. This is done in order to prevent the message contents from being accessed at a later time by someone besides the recipient. Alternately, the system operator may choose to archive, maintain unencrypted or encrypted copies of the messages consistent with the message retention policies of the user (which can be an individual or a company) or the expected usage of the system.

Sending a Message

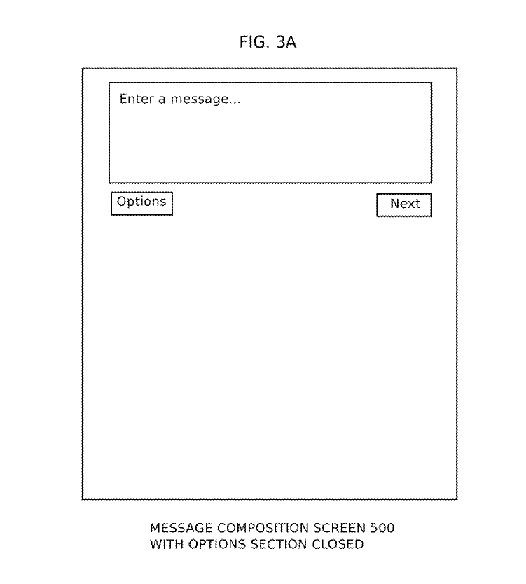

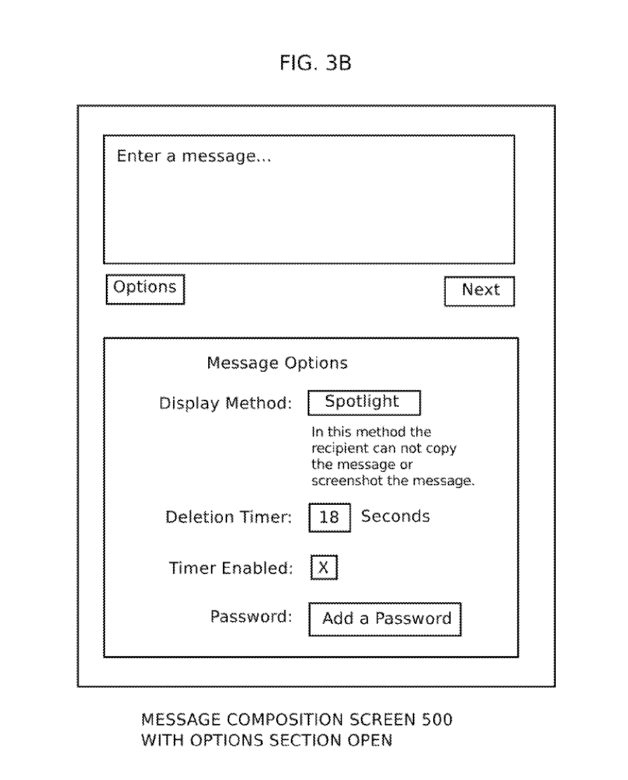

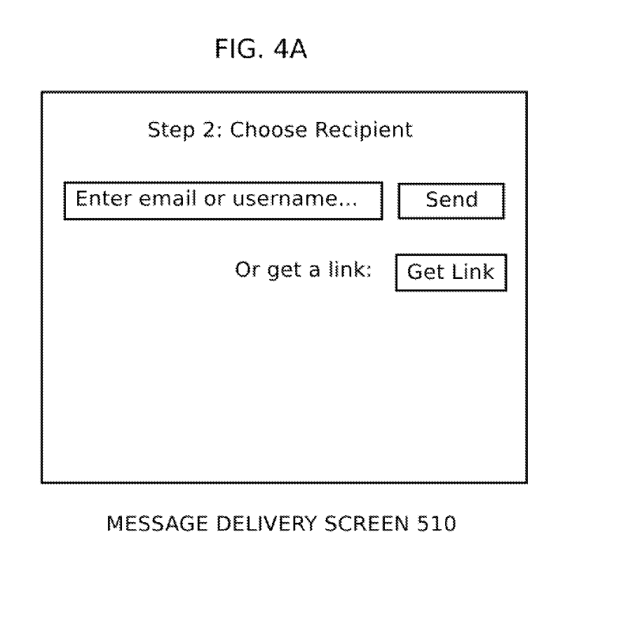

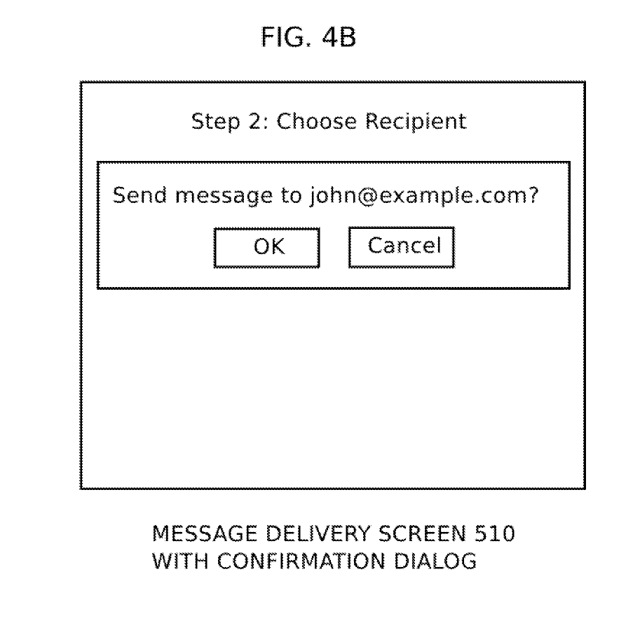

In accordance with an exemplary embodiment of the claimed invention, as shown in FIGS. 3A-4B, each client device 200 (or each sender's client device 200) comprises a set of graphical user interfaces (GUIs) screens which are shown on the display 220 for composing, editing and sending messages. An arrangement of the various screens displayed on the display 220 of the client device 200 can include user interface elements to enable the user to perform various tasks, e.g., composing, editing and sending messages. In accordance with an exemplary embodiment of the claimed invention, the message sending process can involve a message composition and display options screen 500 (or simply referred to as the message composition screen 500) on the display 220, as exemplary shown in FIGS. 3A-3B, followed by a message delivery screen 510 (or a recipient information screen 510) on the display 220, as exemplary shown in FIGS. 4A-4B. For example, the default screen arrangement of the client device 200 can include a button labeled “new” which activates the message composition and display options screen 500, as exemplary shown in FIG. 3A. Although the “new” button can be placed anywhere, the “new” button is preferably located on the upper right corner or section of the default screen.

Unlike the compose procedure in a typical e-mail device, the claimed invention preferably places the recipient information screen 510 after the message composition screen 500. Although the users are comfortable specifying the recipient of the message after they have composed it, the system operator can alternatively implement the claimed invention where the recipient specification comes before the message composition similar to a typical e-mail device.

In accordance with an exemplary embodiment of the claimed invention, the client device 200 combines the message composition and message display options onto a single screen 500, as exemplary shown in FIGS. 3A-B, but it is appreciated that they can be placed on two separate screens. As exemplary shown in FIG. 3A, the single screen 500 can consist of a text input area which is configured to be roughly the size of a typical message, and an “options” button underneath the text input area. Also, as exemplary shown in FIG. 3A, the single screen 500 can include a “next” button to proceed to the recipient information screen.

When the sender creates a new message on the sender's client device 200, the server 100 and/or the sender's client device 200 performs various tasks to package the message for use in the claimed system. In accordance with an exemplary embodiment of the claimed invention, the server 100 or the sender's client device 200 encrypts the message contents; sender selects the details as to how the message is to be displayed on the recipient's client device 200 and the sender's selection is stored in the message; metadata about the size of the message is stored in order to allow the recipient device 200 to display a representation of the message that is the correct size on the display 220 of the recipient device 300; and the recipient information must be specified by the sender and stored in the message.

Message Creation, Encryption

In accordance with an exemplary embodiment of the claimed invention, the processor 110 of the server 100 (or the processor 210 of the sender's client device 200 in certain exemplary embodiment) encrypts the contents of each message before transmitting the message to the recipient's client device 200. It is appreciated that the claimed system can operate without an encryption component, but this will significantly lower the security of the system. Therefore, only system operators who have low security concerns should operate the claimed system without the encryption component. It is appreciated that any existing encryption system can be used with the claimed invention.

In an exemplary embodiment of the claimed invention, the server 100 utilizes the symmetric key encryption. The server 100 generates a random 12 character key when the client device 200 initiates a new conversation. The random key can be generated using a cryptographically secure random number generator which is part of a widely distributed cryptographic library. When the sender clicks the OK button on the delivery confirmation modal dialog displayed on the display 220, the sender's client device 200 sends a request to the server 100 using the Internet connection facility 260, which can be a wired or wireless connection device, to create a new conversation over the communications network 300. The server 100 receives the request via the Internet connection facility 140, which is generally a wired connection device to provide a secure and reliable connection to the communications network 300, and responds with information about the conversation including the conversation key to use for encrypting and decrypting conversation messages. The sender's client device 200 receives the information including the conversation key from the server 100 via the Internet connection facility 260. The sender's client device stores the received conversation key in the storage 250. The processor 210 of the sender's client device 200 encrypts the message contents using the stored conversation key and sends only the encrypted message contents to the server 100 over the communications network 300. The server 100 stores the encrypted message contents in the storage 250 until the messages contents are accessed or retrieved by the client device 200 associated with the recipient. The server 100 transmits a notification to the recipient device 200 associated with the recipient that they have a message. When the recipient using the recipient device 200 requests or attempts to access the message, the server 100 transmits or sends the conversation key and the encrypted message contents to the recipient device 200 upon verification that the user is the authorized recipient of the message. The processor 210 of the recipient's client device 200 decrypts the message contents using the conversation key.

In accordance with an exemplary embodiment of the claimed invention, the claimed system can utilize a public key encryption system (such as GNU Privacy Guard or GPG) between registered or authorized users of the claimed system. Each client device 200 of a registered user generates its own public/private key pair and sends only the public key to the server 100 over the communications network 300. The server 100 stores the received public key in the storage 130. The server 100 associates the public key received from a particular client device 200 with the user account of the user that is associated with that particular client device 200. The server 100 sends the public key of the recipient to the sender's client device 100 over the communications network 300 and the processor 210 of the sender's client device 200 use the public key of the recipient client device 200 to encrypt the message contents of the message to be transmitted to the recipient client device 200. One advantage of using the public key encryption system is that only registered user having access to the server 100 can access the decrypted contents of a message. It is appreciated that the claimed system can employ the symmetric key encryption method when the sender is communicating with a recipient who does not yet have a registered account on the system or the server 100 can send notification to the recipient's client device to become a registered user of the claimed system to securely send and receive messages.

Message Creation, Display Options

In accordance with an exemplary embodiment of the claimed invention, the sender can control certain settings which effect how the recipient will interact with their message. The composition screen displayed on the screen 220 of the sender's client device 200 includes an “options” button below the message text input area, as exemplary shown in FIG. 3A. When the options button is clicked by the sender, as exemplary shown in FIG. 3B, the sender's client device 200 presents a display options section for controlling and setting various message options on the screen 220. For example, when the sender clicks OK on the pre-delivery confirmation dialog in the display option section, the sender's client device 200 reads the state of the controls in this display options section, serializes their values, and sends them to the server 100. The server 200 stores the values along with the message received from the sender's client device 200 in the storage 130. These stored values are used when the recipient accesses the message and they are sent to the recipient's client device 200 when the recipient views the message.

It is appreciated that default display options values are used and sent with the message when sender does not change these display options or control settings. Generally, the senders do not bother to change these display control/options settings, so the system operator should select default values that best represent the expected use of their system.

In accordance with an exemplary embodiment of the claimed invention, the sender can choose which method the system will used in displaying their message contents to the recipient on the display 220 of the recipient's client device 200. The sender's client device 200 provides a drop down menu which lists one or more display methods that can be selected by the sender. Preferably, the sender's client device 200 displays short descriptions of the display methods alongside each display method or when the sender places a selector (e.g., a cursor) over each display method.

In accordance with an exemplary embodiment of the claimed invention, as exemplar shown in FIG. 3B, the sender can set the time in seconds of the message countdown/destruction timer 270 for the message in the display options section/area. For example, the sender can set the message countdown/destruction timer 270 to 10 seconds so that the message will self-destruct (i.e., deleted from the server 100 and/or the recipient's client device 200) in 10 seconds after the recipient first views the message. In accordance with an exemplary embodiment of the claimed invention, the text input area of the message composition and message display options screen of the sender's client device 200 displays the default value of the message countdown/destruction timer 270 in seconds which can be changed by the sender. It is appreciated that other types of user interface elements can be utilized to enable the sender control and change the message countdown/destruction timer 270.

Typically, the users do not bother to change the default value of the message countdown/destruction timer 270. In accordance with an exemplary embodiment of the claimed invention, the client processor 210 of the sender client device 200 automatically sets the message countdown/destruction timer 270 for each message based on the length of the message content. In accordance with an exemplary embodiment of the claimed invention, the client processor 210 sets the message countdown/destruction timer 270 for a given message based on greater of the message length in number of characters or a fixed value 15, and divides the resulting value by 3. The fixed value 15 insures that no message has a message countdown/destruction timer 270 set to less than 5 seconds, thereby ensuring that the recipient has sufficient time to read the message before the message self-destructs. It is appreciated that any other fixed value or any other method of calculating the length of the message countdown/destruction timer 270 can be used, all of which are within the scope of the claimed invention.

In accordance with an exemplary embodiment of the claimed invention, as exemplary shown in FIG. 3B, the sender can disable the message countdown/destruction timer 270 so that it does not activate when the recipient first views the message. For example, the sender can unclick (or uncheck) the checked delete timer box user interface element within the message display options area, which is enabled by default, to disable the message countdown/destruction timer 270.

In accordance with an exemplary embodiment of the claimed invention, as exemplary shown in FIG. 3B, the sender can add a password to the conversation (or the message). If the sender has selected the password option, then the recipient must enter the password before they can access the message. The password option provides an additional level of security.

Message Creation, Message Contents Metadata

In accordance with an exemplary embodiment of the claimed invention, certain metadata about the message contents is recorded/stored and transmitted by the server 100 and/or the sender's client device 200 when the message is created by the sender. For example, the sender's client device 200 records a piece of metadata relating to the time that the message was created in the storage 250. For example, the client processor 210 of the sender's client device 200 records a Unix timestamp as the message creation time in the storage 250. It is appreciated that any other known timer/timestamp can be used. For example, another piece of metadata may describe how much space it takes to display the message contents on the recipient's client device 200. This message display size metadata is transmitted to the recipient's client device 200 so it can display the message cover when the recipient accesses the message on the display 220 of recipient's client device 200. The message cover should be the same size as the display size of the message when presented/viewed on the display 220 of the recipient's client device 200. In order to create the correct cover size, in accordance with an exemplary embodiment of the claimed invention, the client processor 210 of the sender's client device 200 and/or the server processor 110 of the server 100 records the total number of characters in the message rounded up to the nearest multiple of 10 and the total number of lines in the message in the storage 250 and storage 130, respectively. In order to securely transmit the message from the sender's client device 200 to the recipient's client device 200, care must be taken to ensure that the metadata does not reveal any significant information about the message content. For example, the server 100 and/or the sender's client device 200 should not record the exact number of characters in the message. Instead, the server 100 and/or the sender's client device should record a representative number, such as the number of characters in the message rounded up to the nearest multiple of 10. This way, for example, the messages whose contents are “yes” and “no,” respectively, have the same metadata.

In accordance with an exemplary embodiment of the claimed invention, the client processor 210 of the sender's client device 200 records the number of lines in a message in the storage 250 by counting the number of newline character sequences in the message.

In accordance with an embodiment of the claimed invention, the client processor 210 of the sender's client device 200 records the message display size metadata by generating an array of integers where each element in the array represents the length of one line in the message rounded up to the nearest multiple of 10. The client processor 210 of the sender's client device serializes the array using any known serialization method and included along with the encrypted message contents when the message is delivered.

It is appreciated that the sender's client device 200 may omit the recording and transmitting the message display size metadata which is used to determine the size of the message representation on the display 220 of the recipient's client device 200. The only disadvantage of omitting the message display size metadata is that the recipient will find the user interface less intuitive on its client device because the recipient's client device 200 utilizes this metadata to properly size the message representations on its display 220.

Message Creation, Recipient Information

In accordance with an exemplary embodiment of the claimed invention, using the user input device 230 or touch screen 220, the sender enters her message contents in the text input area and optionally specifies display options by clicking the options toggle and adjusting the default values for the various display options on the sender's client device 200. The sender then clicks the “next” button to proceed to the recipient information page/screen or message delivery screen 510.

In accordance with an exemplary embodiment of the claimed invention, the recipient information page/screen comprises a text input area where the sender can enter the e-mail address or system username of the recipient, as exemplary shown in FIG. 4A. Preferably, as the user types the address or username in the text input area, the client processor 210 displays auto-complete options below the input area consisting of addresses/usernames of the previous recipients. In accordance with an exemplary embodiment of the claimed invention, the recipient information page/screen further comprises a button which lets the user skip the process of transmitting the message to the recipient's client device 200. The sender's client device 200 obtains a link to sender's message from the server 100 and displays the link on the sender's client device 200. The sender can then copy this link from their client device 200 and deliver it to the recipient outside of the system, such as via a text message, social-media website posting and other comparable means. The link enables the recipient to access the sender's message. This button can be located below the recipient information text input element or anywhere within the recipient information page/screen. In accordance with an exemplary embodiment of the claimed invention, the sender's client device 200 transmits a code, instead of a link, to the recipient's client device 200 over the communications network. The recipient's client device 200 can access the message stored on the server 100 by providing/entering the code received from the sender's client device 200.

Message Creation, Delivery Confirmation

After the sender specifies the recipient information, the sender's client device 200 displays a modal confirmation dialog on the display 220, as exemplary shown in FIG. 4B. The modal confirmation dialog displays the recipient information for the sender to confirm or change to a different recipient before the message is transmitted to the recipient's client device 200. Although this feature is not necessary for the functioning of the system, it is highly desirable to add such a safety mechanism to prevent an accidental delivery of the message to the wrong recipient. In accordance with an exemplary embodiment of the claimed invention, as exemplary shown in FIG. 4B, the delivery confirmation can have the following modal dialog: “send message to john@example.com? OK/Cancel”. If the sender clicks “OK” in the modal dialog, the sender's client device 200 initiates the delivery process or message transmission. If the sender clicks “Cancel,” the display 220 hides the modal dialog and presents the recipient information screen to the sender.

Message Creation Alternative: 3RD Party Source

In accordance with an exemplary embodiment of the claimed invention, the claimed system permits a programmatic access for a third party source to create messages for transmission within the system. That is, the sender's client device 200 actions are performed by another source, such as a server that is part of another system. This can be useful to allow companies to send messages which have all the security properties of the claimed system to recipients who are part of the claimed system.

Message Delivery

In accordance with an exemplary embodiment of the claimed invention, the message contents are not initially delivered to the recipient's client device 200 to maintain secure control over the content of the messages delivered within the claimed system. Instead the server 100 delivers a notification to the recipient's client device 200 that they have received a message. Preferably, the notification includes the account user-name of the sender, but this can be omitted to increase the privacy of the claimed system. In accordance with an aspect of the claimed invention, although less secure, the server 100 can include the message in the initial notification to the recipient's client device 200 as long as the message are not initially displayed on the display 220 of the recipient's client device 200.

In accordance with an exemplary embodiment of the claimed invention, the recipient information consists of an e-mail address or username of the recipient on the system. Alternatively, there may be no recipient information if the sender elects to use a link or code to deliver the message to the recipient's client device 200. If the recipient information consists of an e-mail, the server 100 cross references the e-mail against registered e-mail accounts on the system. If the specified e-mail address is that of a registered user, the server 100 returns the user-name of the registered user/recipient to the sender's client device 200. The display 220 of the sender's client device 200 displays the recipient user-name in the final confirmation dialog to the sender before the message is sent along with a message explaining that the specified email address of the recipient belongs to a registered user of the claimed system. However, if the recipient information consists of an e-mail that does not match any registered user, then the server 100 sends an e-mail to the recipient's e-mail address. The email includes a link to access the message along with text explaining that they have received a message and providing the user-name of the sender.

If the recipient information consists of a user-name (e.g., an e-mail address was translated into a user-name), then the server 100 sends a notification message to the recipient user in accordance with the recipient user's preference, i.e., a preferred method specified by the recipient user. These preferences can be one of the following: an e-mail to the recipient user's registered e-mail address, a notification sent directly to the recipient user's client device 200, a text message to the recipient user's phone or no notification. Alternatively, the server 100 can delegate the transmission of the notification message to the sender's client device 200. For example, the delivery options page/screen can include a button which activates a local contacts feature of the sender's client device 200, similar to features currently existing on touch screen cell phones.

Recipient Authentication

In accordance with an exemplary embodiment of the claimed invention, when the recipient has a new message, the server 100 sends a notification to the recipient's client device 200 over the communications network 300. The notification directs the recipient to access the claimed system, specifically the server 100, to view the message. In certain embodiments, the notification has a link which takes the recipient's client device 200 to a particular webpage of the server 100 or an unique identifier for the recipient to view/read the message. In certain other embodiments, the recipient is directed to login into her account using her client device 200 to check and view her messages.

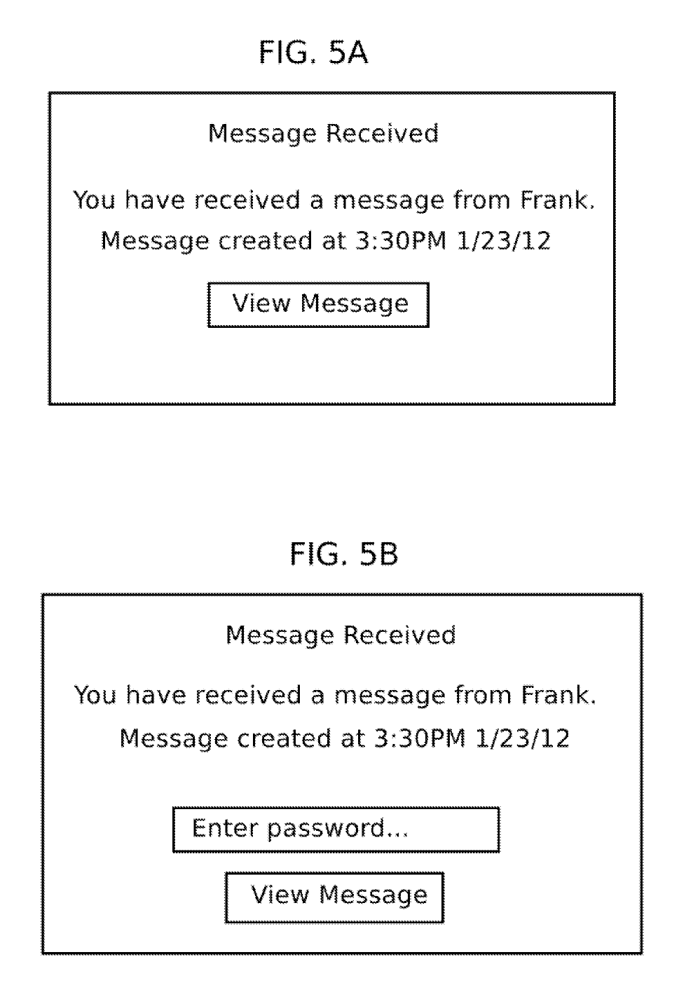

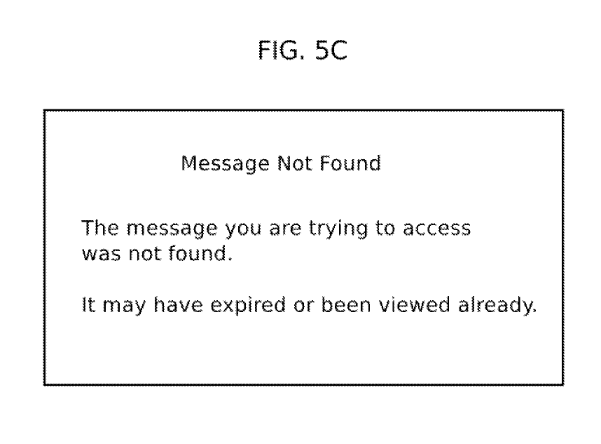

When the recipient uses her client device 200 to initiate an access to her messages, the server 100 (i.e., the email system) presents a cover page for the message on the display 220 of the recipient's client device 200. In accordance with an exemplary embodiment of the claimed invention, as exemplary shown in FIG. 5A, the message received cover page displays the time at which the message was created, the name of the sender, and a button or other user interface element to initiate the viewing of the message. The displayed version of the date is translated from the Unix timestamp (or other comparable timestamp) in which it is stored, into a textual representation of the date and time adjusted to the local time zone of the recipient's client device 200. If the message has already been deleted, as exemplary shown in FIG. 5C, the message received cover page displays a short message indicating that there is no longer a message present. In certain embodiments, as exemplary shown in FIG. 5B, the message received cover page also has an area for the recipient to enter a password to view the message if the sender has protected the message with the password. Additionally, if the recipient of the message is a registered user of the system, then the server authenticates the recipient to her account, either by requesting the recipient to login into her account or automatically logging in the recipient to her account using a cookie stored on the recipient's client device 200 if the recipient opted to stay logged in with the cookies.

When the recipient clicks the part of the message received cover page to view the message, the client application running on the recipient's client device 200 instructs the processor 210 to send a request (with the user-supplied password, if applicable) to the server application running on the server 100 over the communications network via their respective Internet connection facilities 260, 140. If a password is supplied by the recipient and the processor 110 of the server 100 determines that the password is incorrect, then the processor 110 of the server 100 notifies the client application of the error. The processor 210 then displays that password is incorrect on the display 220 of the recipient's client device 200. If the password is not required or the recipient supplies the correct password, then the processor 110 of the server 100 grants the client application on the recipient's client device 200 access to the message and updates server's internal record to indicate that the recipient's client device 200 has been granted access to the message.

Viewing a Message

When the user/recipient views a message on the server 100 using the client application running on the recipient's client device 200, the client processor 210 of the recipient's client device 200 displays the message on the display 220 based on the method and format selected by the sender, such as one of the following methods described herein: the Plain Text method, the Spotlight method and the Video method. It is appreciated that any other comparable methods can be utilized by the claimed invention to display the message on the recipient's client device 200.

In accordance with an exemplary embodiment of the claimed invention, the client processor 210 of the recipient's client device 200 renders the text contents of a message using a font color with low contrast against the background on the display 220. For example a light grey font on a dark grey background on the display 220 of the recipient's client device 200. This has the advantage of making the message contents harder for someone else in the vicinity of the recipient to read. However, the text contents of the message should be rendered using a high contrast color against the background on the display 220 for older users or those with vision impairment. Otherwise the recipient may be unable to read the message contents even though they are displayed in front of them. It is appreciated that different font color with higher or lower contrast can be utilized to achieve different level of protection against unwanted accessibility.

Viewing a Message in the Plain Text Method

In accordance with an exemplary embodiment of the claimed invention, the sender can select to have their messages displayed in plain text on the recipient's client device 200. Although the plain text method does not provide protections against digital recording of the messages or other people viewing the message, the claimed system still provides automatic deletion of the messages from the sender's client device 200, the recipient's device 200 and the server 100. The plain text method can be utilized by the sender to permit the recipient to digitally copy the message but the sender can enhance the security of the plain text method by encrypting the message or using password protected message.

Viewing a Message in the Spotlight Method

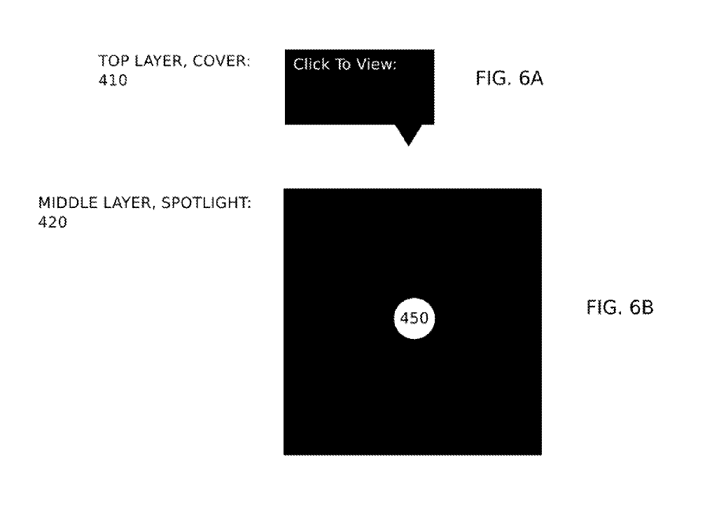

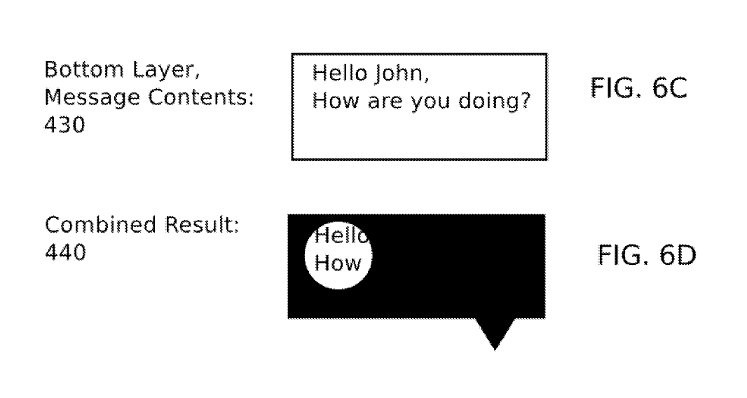

In accordance with an exemplary embodiment of the claimed invention, as shown in FIGS. 6A-D, the system and method provides a spotlight display of the message contents to prevent recipients from capturing message contents or others in physical proximity to the recipient from seeing the message contents. The claimed spotlight method is applicable to text, photo, other rich media message contents or any screen-displayable message contents to protect against capture via copy and paste functionality, a screenshot or other image-taking device or functionality, or viewing of the message by another person in the close vicinity to the recipient.

In accordance with an exemplary embodiment of the claimed invention, the recipient's client device 200 displays on the screen 220 a note or message contents behind a cover which entirely obscures the message/note. Preferably, as shown in FIG. 6A, the cover 410 has some explanation to indicate to the recipient that it is a message. For example, the explanation may include a label such as “Click to view” or “Tap to view”. In accordance with an exemplary embodiment of the claimed invention, the cover 410 can also include graphic styling which makes it look like a text bubble as found in chat and SMS applications. The cover 410 provides a representation of the message while preventing the message contents from being visible to the recipient. Preferably, the explanation label of the cover utilizes a large font in a color which has high contrast against the cover back ground to make the cover suitable for older users and those with vision impairment. Of course, the explanation label can be utilized a smaller font in color with less contrast.

In accordance with an exemplary embodiment of the claimed invention, when the user clicks and holds down the mouse button on the cover 410, as shown in FIG. 6D, the processor 210 of the recipient's client device 200 presents a small hole 450 in the cover 410 wherever the mouse 220 is. This hole 450 is called the “spotlight” and the spotlight or hole 450 reveals a section of the message content where the mouse or cursor is located. On a touch screen device 200 (e.g., a tablet), in accordance with an exemplary embodiment of the claimed invention, the user can touch the cover 410 on the touch screen 220 with their finger and hold their finger down on the cover 410 to start the spotlight mechanism. The processor 210 of the user's client device 200 displays the spotlight area 450 above and to the left of the place where the user touch the cover on the touch screen 220 so that the user's finger(s) does not obscure the spotlight area 450. On a desktop or laptop computer 200 using a mouse 230, in accordance with an exemplary embodiment of the claimed invention, the processor 210 of the user's client device 200 (i.e., the desktop or laptop computer) displays the spotlight area 450 directly above the location of the mouse 230 and hides the mouse cursor while the spotlight is open. As shown in FIG. 6D, the user can see a small portion of the document through the spotlight 450 while it is open but the user can never see the entire document. That is, the spotlight exposes a space big enough to read a few words or see a recognizable portion of a photo. The user can move the mouse 230 while holding the mouse button or can move their finger(s) while holding it on the touch screen 220 to move the spotlight 450 to view another portion/section of the document. The processor 210 of the user's client device 200 enables the user to view an entire text document or photo but does not reveal the entire document or message content at any given point in time. When the user releases the mouse button or their finger, the processor 210 close the spotlight on the display 220 and the cover 410 returns to its initial state where none of the message contents are visible.

In accordance with an exemplary embodiment of the claimed invention, the processor 210 of the user's client device 200 keeps the spotlight 450 open for a predetermined period of time, preferably a short period of time, if the user clicks or taps quickly on the cover. For example, the processor 210 keeps the spotlight open for 330 milliseconds after the user clicks or taps the cover if the duration of their click or tap is under 330 milliseconds. This delay in closing the spotlight by the processor 210 after a short click is to provide a working demonstration of the spotlight mechanism to the recipient. In accordance with an exemplary embodiment of the claimed invention, the processor 210 can eliminate this small delay period in removing the transparent section if the recipient has kept the spotlight open for a long period of time indicating their comprehension of the spotlight mechanism. For example, the processor 210 of the recipient's client device 200 closes the spotlight immediately after the user clicks or taps the cover if the duration of their click or tap is over 330 milliseconds.

Since the mouse button or the user's finger must be held down to keep the spotlight open, taking screenshots or photos requires more finger coordination which effectively blocks many users from capturing the contents of messages presented on the display 220 using the claimed spotlight method. Capturing the entire message contents via screenshots or other image-taking device or functionality would require taking many, carefully coordinated images which effectively blocks many users from capturing the contents of messages presented on the display 220 using the claimed spotlight method. Re-assembling a collection of images where each image holds a different piece of the contents of a message displayed with the claimed spotlight method requires advanced tools and skills which effectively blocks many users from capturing messages presented on the display 220 using the claimed spotlight method. Furthermore, authenticity of such composite image created from a collection of images generated through such effort may be questionable and not useful in many legal and other contexts.

Additionally, the claimed spotlight method of presenting the message content on the display 220 to the recipient prevents other people who are physically near the recipient from easily viewing the message contents while it is viewed/read by the recipient. When the recipient is actively viewing the message contents, only the section that the recipient is looking at is visible on the display 220 which makes it difficult for another person to view the whole message as they must exactly synchronize their viewing pattern with the recipient's.

Further, the claimed spotlight method of presenting the message content on the display 200 to the recipient prevents other people who are physically near the recipient from viewing the message contents when the recipient is not actively clicking or touching the message cover. This increases the privacy of the message in many situations, for example, if a recipient puts their smart phone down on a table after reading the message and there are other people at the table, none of the other people can see the message contents because the message content is not visible on the display 220 when the spotlight is not active. There are significant social barriers which prevent people from touching the screen of a client device 200 which does not belong to them or clicking on the mouse of a computer that is used by another person. These social barriers effectively prevent people near the recipient's client device 200 who could easily see the contents of a regular message left open from viewing the contents of a message displayed with the claimed spotlight mechanism on the recipient's client device 200 left open but not actively being clicked or touched by the recipient.

In accordance with the exemplary embodiment of the claimed invention, the message is stored on the server 100 until the message contents are requested by the recipient's client device 200 as part of a “message open” request by the recipient's client device 200. In response to the message open request, the server 100 delivers or transmits the message contents to the recipient's client device 200 over the communications network 300 and the server processor 110 of the server 100 deletes the message contents from the storage 250 after a predetermined time period. For example, the server processor 110 can start a countdown timer 150 and delete the message contents from the storage 250 when the countdown timer 150 expires.

Once the recipient initiates the view of the message on the recipient client device 200, the client application running on the recipient's client device 200 instructs the client processor 210 to retrieve the message contents from the server 100 over the communications network 300. To display the message contents on the screen 220 to the recipient/user, in accordance with an exemplary embodiment of the claimed invention, as exemplary shown in FIGS. 6A-6D, the client processor 210 executing the client application renders three layers 410, 420, 430 on top of each other on the display 220 of the recipient's client device 200. As shown in FIG. 6A, the top layer 410 is an image which is used as a cover page 410 and is completely opaque. The top layer 410 has the same size and shape as the message displayed on the screen 220 of the recipient's client device 200. As shown in FIG. 6C, the bottom layer 430 is the message. As shown in FIG. 6B, the middle layer 420 is an image that is completely opaque except for a small transparent hole 450 in the middle or a “spotlight” 450. The middle layer 420 is preferably as tall as twice the height of the message plus the height of the transparent spotlight area/region 450. The image of the middle layer 420 is preferably wide as twice the width of the message plus the width of the spotlight 450. These preferable dimensions allow the middle layer 420 to be moved around by the user to locate the spotlight 450 over any part of the underlying message without exposing any part of the message that is outside of the spotlight 450.

In accordance with an exemplary embodiment of the claimed invention, the recipient's client device 200 moves the middle layer 420 by adjusting the X and Y offset values in pixels of the middle layer image relative to the top and left of the screen 220 of the recipient's client device 200. The client processor 210 of the recipient's client device 200 calculates the values equivalent to half the width of the middle layer image and half the height of the middle layer image. When the spotlight is to be moved to a new destination point on the screen 220, the client processor 210 takes X and Y coordinates of the new destination point, subtracts the half width X and Y values from the X and Y coordinates of the new destination point, respectively, and then sets the X and Y values for the upper left corner of the middle layer image to the resulting values. This positions the portion of the middle image which makes up the spotlight area to be directly located at the desired point. For a mouse click, the client processor 210 adjusts the target point to be 10 px higher than the actual location of the user's click. Preferably, the client processor 210 subtracts 10 px from the input click's Y value before performing the position adjustment process on the middle layer image. For a touch screen touch, the processor adjusts the target point to be 10 px higher and 20 px to the left of the actual location of the user's touch. Preferably, the client processor 210 subtracts 10 px from the input point's Y value and 20 px from the input point's X value before performing the position adjustment process on the middle layer image. Although, 10 px vertical and 20 px horizontal offset values were used in this example, different offset values can be also used to achieve the desired result.

When the user presses their mouse button down on a location inside the message/note contents, or if they do an equivalent action like pressing and holding on a touch-screen device 200, in accordance with an exemplary embodiment of the claimed invention, the client processor 210 of the client device 200 moves the middle layer 420 so that the spotlight 450 is located right above their click location on the screen 220 and then removes the top layer 410. This results in the effect of the spotlight opening right above where the user generated input, as shown in FIG. 6D. In accordance with an exemplary embodiment of the claimed invention, the processor 210 removes the top layer by setting its “display” property to “none” in the CSS style sheet (Cascading Style Sheet) which is part of the client application. When the user moves her mouse 230, or performs an equivalent move like moving their finger on a touch-screen device 200, the client application running on the client device 200 instructs the client processor 210 to move the middle layer 420 so that the spotlight 450 is repositioned above where mouse 230 (i.e., the mouse cursor) moved to. If the user releases the mouse button, or performs an equivalent action like releasing their finger on a touch-screen device 200, the client application instructs the client processor 210 to display the top layer 410 on the screen 220 again to completely block out the message contents or the bottom layer 430. Preferably, the client processor 210 hides the mouse cursor from display 220 while the mouse button is depressed, thereby giving the impression to the user that they are moving the spotlight 450 instead of the mouse 230.

Viewing a Message in the Video Method

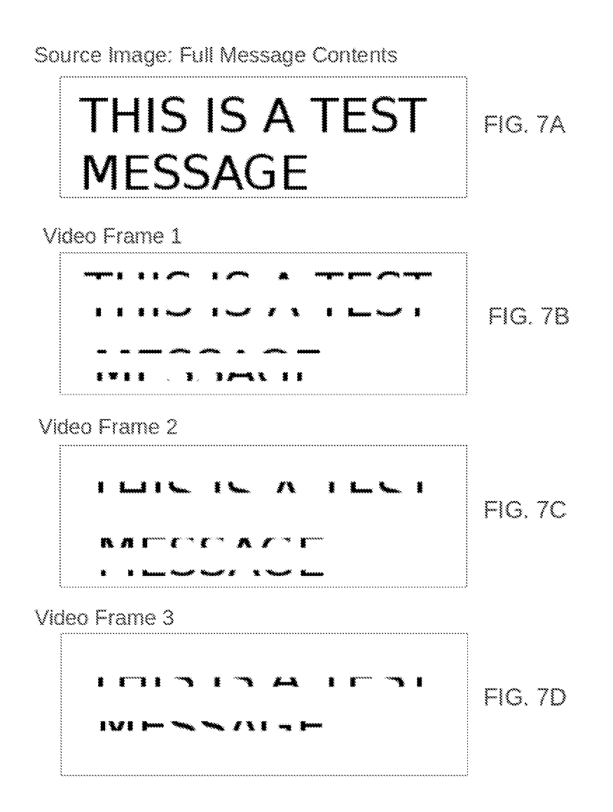

In accordance with an exemplary embodiment of the claimed invention, as shown in FIGS. 7A-D, the claimed system provides a video display of the message contents to prevent recipients from capturing message contents. The video display method is applicable to text, photo, other rich media message contents or any screen-displayable message contents to protect against capture via copy and paste functionality, or screenshot or other image-taking device or functionality.

If the message contents consist of text, as exemplary shown in FIG. 7A, the server processor 110 converts the text into an image. The processor 110 then converts the image into a set of partial images, each of which has a portion of the original message but is incomplete on its own. The server processor 110 generates a movie by using the partial images as the individual movie frames and repeats them in a loop. The processor 110 stores the message content in the various formats (e.g., text, image, partial images, and movie) in the storage 130. When the message is displayed to the recipient on the screen 220 of the recipient's client device 200, as shown in FIGS. 7B-D, the client processor 210 of the client device 200 presents the movie in a flickering but still viewable version of the message contents on the screen 220 to the recipient. However, a screenshot or other image capture taken of the movie will result in a partial image which is incomplete and unreadable.

In accordance with the claimed invention, the server processor 110 generates the partial images (as exemplary shown in FIGS. 7B-D) from the original image of the message contents (as exemplary shown in FIG. 7A) by removing a series of vertical or horizontal strips from the original image and leaving vertical or horizontal strips which show no more than a word or two before there is a removed section. This is similar to taking the strips output by a paper shredder and keeping only every 2^{nd} strip or every 3^{rd} strip and then gluing those kept strips, in the same order and position as they were in the original, onto a blank piece of paper that is the same size as the original. It is appreciated that the size and shape of the sections taken from the original message can be any geometric shape, a collection of geometric shapes, a collection of arbitrary shapes, or a collection of random shapes as long as none of the sections are large enough to contain a significant portion of the message contents.

In accordance with an exemplary embodiment of the claimed invention, the server processor 110 executes the server application stored in the memory 120 of server 100 to generate the video image of the message content when a request to view the message is received by the server 100 from the client application running on the recipient's client device 200 over the communications network 300 via the respective Internet connection facilities 140, 260. The server 100 stores the message in its original format (i.e., in its text format as exemplary shown in FIG. 7A) in the storage device 250 until it is requested by the recipient's client application running on the recipient client device 200. Upon receipt of the request to view the message from the recipient's client device 200, the server application instructs the server processor 110 to transform the message contents into another object which can act as the source of the movie. The server processor 110 transmits the movie source object to the recipient's client device 200 over the communications network 300 and deletes the message from the storage device 130.

In accordance with an exemplary embodiment of the claimed invention, the server application running on the server processor 110 accesses a graphics utility to generate arbitrary sized images and copy image sections between images at arbitrary positions. For example, the server application is enabled to access the GD (GIF draw or graphics draw) library included with the PHP (hypertext preprocessor) programming language. The server processor 110 renders the message contents into an image using the GD library.

In accordance with an exemplary embodiment of the claimed invention, the server application running on the server processor 110 renders the message content with the font file and the graphics utility which can create arbitrary sized images and insert text into them at arbitrary positions using the font file. It is appreciated that the server application needs to be configured with certain information about the font file, e.g., how many letters of the font fit across a certain pixel width. In accordance with an exemplary embodiment of the claimed invention, the processor 110 utilizes the “em” width of the font and transforms the em width into a pixel measurement. The em width is the width of a capital letter “M” in the font file. The M is the widest letter of any font. It is appreciated that using the em width will result in extra space because most letters are smaller than the letter M. Alternatively, the processor 110 can utilize a fraction of the M width. Another piece of information that the server application needs to be configured with is the height of the font in pixels, which is a fixed value and generally accompanies the font file.

When rendering a given message, in accordance with an exemplary embodiment of the claimed invention, the server processor 110, running the server application, determines the width in pixels of the display 220 of the recipient's client device 200. It is appreciated that this information can be included in the request to view the message from the recipient's client device 200. The server processor 110 divides the display pixel width by the pixel width of the average letter of the font. This determines how many letters can be rendered across the image. In accordance with an exemplary embodiment of the claimed invention, the server processor 110 generates an array of lines out of the message by breaking the message on line breaks or on spaces between words so that the lines and the words in the lines appear in the same order as in the original message. The server processor 110 also ensures that none of the lines are longer than the amount of letters which can be rendered across the image.

In accordance exemplary embodiment of the claimed invention, the server processor 110, running the server application, generates a blank image to render the text on. The exemplary blank image can be wide as the display width of the recipient's client device 200 and the height of the exemplary blank image can be equivalent to the number of lines in the array multiplied by the height of the font. It is appreciated that the image dimensions can include padding. The server processor 100 iterates through the lines and renders each line onto the image. For each line, the server processor 110 increases the offset from the top of the image by the height of the font. This results in an image of the message contents that the client processor 210 of the recipient's client device 200 can display on its screen 220.

To create the partial images, in accordance with an exemplary embodiment of the claimed invention, the server processor 110, running the server application, generates a blank image for each partial image which is the same size as the original image. The server processor 110 iterates through the each of the partial images and determines the portions of the original image which should appear in that particular partial image. The processor 110 copies those portions of the original image into the corresponding partial image, thereby resulting in a desired set of partial images.

The server processor 100, running the server application, generates a movie from the set of partial images. In accordance with an exemplary embodiment of the claimed invention, the server processor 110 generates a new image which is as wide as the original image and as tall as the height of the original image multiplied by the number of partial images. The server processor 110 iterates through the partial images and copies each one, in its entirety, onto a new image at an offset increasing by the height of the original image. This results in a composite image which contains all the partial images arranged vertically above one another. The server 100 sends the composite image to the recipient's client device 200 in a secure manner, as described herein, over the communications network 300. The client processor 210 stores the received composite image in its storage device 250. When the recipient initiates the viewing of the message on the recipient's client device 200, the client processor 210, running the client application, displays the composite image as the background image to a viewable object, having the same dimensions as the original image, with nothing in it on the display 220. The client processor 210 shifts the vertical offset of the background image by an amount equivalent to the height of the original image repeatedly so that only a portion of the composite image containing one of the partial images is displayed on the screen 220 at any one time. The client processor 210 loops rapidly through the portions of the composite image, shifting the offset back to zero after the last portion is displayed. Preferably, the client processor 210 displays each portion as long as a typical movie frame, which is generally display at 30 frames per second. Higher frame rates are possible to provide a better viewing experience for the recipient, as long such higher frame rates are supported by the recipient's client device 200.

In accordance with an exemplary embodiment of the claimed invention, the server processor 110, running the server application, generates a movie from the set of partial images using a utility for creating movies in contemporary formats such as the H264 encoding. For example, the server application would need access to the ffmpeg library. The server processor 110 can use the utility of the ffmpeg library to generate a movie file out of a series of individual frames. The server application passes the partial images to the library which uses the partial images as frames for the resulting movie. The server processor 110 can utilized the library to generate a longer movie by repeating a series of frames or repeating the series of frames in the arguments passed to the library. The server 100 then transmits the resulting movie file to the recipient's client device 200 in a secure manner, as described herein, over the communications network 300. The client processor, running the client application, stores the received movie file in its storage device 250. Also, the server 100 deletes the movie file from the storage device 130, as described herein, after it is viewed by the recipient. When the recipient initiates the viewing of the message on the recipient's client device 200, the client processor 210 displays the movie on the screen 220.

MESSAGE COUNTDOWN/DESTRUCTION TIMERS

When the recipient first engages with the cover 410 to view the message contents, the client processor 210, running the client application, sends a notification to the server 100 that the message is being viewed by the recipient. The server 100 then relays this notification to the sender's client device 200 and any other client devices 200 associated with users who can view the message. In accordance with an exemplary embodiment of the claimed invention, the client processor 210, running the client application, does not retrieve the message contents from the server 100 until the recipient first engages with the cover 410 of the message. Alternatively, the server 100 preloads or transmits the message contents to the recipient's client device 200. When the recipient first engages the cover 410, each device (preferably, at least one of the following device: the server 100, the sender's client device 200 or the sender's client device 200) starts its respective message countdown/destruction timer 150, 270, which can implemented either in hardware or software. The notification that the recipient has engaged the message cover 410 serves as a trigger to start the respective message countdown/destruction timer 150, 270 in the recipient's client device 200, the server and any other client devices 200 (such as the sender's client device 200) which can view the message. All of the devices (e.g., the server 100 and client devices 200) with a copy of the message delete the message contents when the countdown/destruction timer 150 expires.

In accordance with an exemplary embodiment of the claimed invention, the message countdown/destruction timer resets each time the recipient re-engages the message cover 410. That is, each time the recipient re-engages the message cover 410 before the message countdown/destruction timer expires, the client processor 210 of the recipient's client device 200 transmits a reset notification to the server 100 over the communications network 300. This timer reset functionality is an optional feature that may be useful for novice, disabled or elderly users who may need additional time to view/read the message.

In accordance with an exemplary embodiment of the claimed invention, use of the message countdown/destruction timer within the claimed system is optional. That is, the sender can elect to use the message countdown/destruction timer to ensure that all copies of her messages are timely deleted after it is viewed/read by the recipient. In accordance with an exemplary embodiment of the claimed invention, if the message is sent without the use of the message countdown/destruction timer, then the client processor 210 of the recipient's client device 200 deletes the message contents from its storage device 250 and sends the notification to the server 100 when the recipient closes or minimizes the client application from the screen 220, thereby indicating that the recipient has viewed/read the message. This navigation act by the recipient triggers, the client processor 210 of the recipient's client device to delete the message from its storage 250 and sends a notification to server 100. Upon receipt of the notification, the server 100 deletes its copy of the message from its storage 130 and transmits the notification to the sender's client device 200 to delete sender's copy of the message.

In accordance with an exemplary embodiment of the claimed invention, the client processor 210 displays the progression of the message countdown/destruction timer 270 on the screen 220 of the user's client device 200 to the user. For example, the client device 200 utilizes a graphical element with two sections (i.e., a virtual hourglass), where the client processor 210 decreases the size of one section until it completely disappears similar to a physical hourglass. Alternatively, the client processor 210 displays a number which represents the number of seconds left on the message countdown/destruction timer 270 on the screen 220. This number counts down from the initial value to zero. It is appreciated any other timer displays can be utilized with the claimed invention that best integrates with the look and feel of the client application design. When the message countdown/destruction timer runs out, the client processor 210 deletes the message from its storage 250 and removes the timer from its display 220.

OVERWRITING MESSAGES BEFORE DELETION:

When deleting message contents, in accordance with an exemplary embodiment of the claimed invention, the server 100 and the client application on the client device 200 overwrites the message before deleting in order to ensure that no partial section of the message is left on its respective storage device 130, 250. This is done in the claimed system because certain storage devices deletes by updating the metadata for performance reasons, but do not actually erase the contents from the underlying storage. Accordingly, the claimed system takes precautions to ensure that the storage devices do not maintain caches of contents when creating or reading them. If caches are utilized by the storage devices, then the respective server and client applications empties the caches after a very short period of time in the course of normal operation to prevent or minimize recovery of any contents from the storage devices.

While the present invention has been particularly described with respect to the illustrated embodiment, it will be appreciated that various alterations, modifications and adaptations may be made based on the present disclosure, and are intended to be within the scope of the present invention. It is intended that the appended claims be interpreted as including the embodiment discussed above, those various alternatives which have been described and all equivalents thereto.

What is claimed:

1. A method for securely transmitting information over a communications network, comprising the steps of:
receiving a message notification that a recipient has a message on a recipient's client device from a processor based server upon receipt and storage of the message from a sender's client device in a storage device by the server over the communications network;
accessing the server to view the message by the recipient using the recipient's client device over the communications network; and
rendering and displaying the message on the recipient's client device in accordance with a display method selected by a sender of the message to present only a portion of the message at any given time to the recipient, thereby preventing recording or capture of the message.

2. The method of claim 1, further comprising the steps of:
retrieving from the server, the message with a message cover to entirely obscure the message when displayed by the recipient client device;
displaying the message cover on a screen of the recipient's client device which entirely obscures the message; and
displaying a hole having a predetermined shape and size in the message cover, within proximity of an area of the screen tapped or clicked by the recipient, to reveal the portion of the message underneath the hole, thereby preventing others in proximity of the recipient from viewing the message displayed on the recipient's client device.

3. The method of claim 2, further comprising the step of moving the hole to reveal a different portion of the message by clicking or tapping a different area of the screen by the recipient.

4. The method of claim 2, further comprising the step of closing the hole to entirely obscure the message when the area of the screen tapped or clicked is released by the recipient.

5. The method of claim 2, further comprising the step of closing the hole to entirely obscure the message after predetermined period of time.

6. The method of claim 1, further comprising the steps of:
converting the message into a set of partial images by the server, each partial image containing a portion of the message, when the recipient's client device access the server to view the message;
generating a movie representative of the message by the server using the partial images as an individual movie frames;
storing the partial images and the movie in the storage device by the server; and
transmitting the movie representative of the message to the recipient's client device, each individual frame of the movie representing a portion of the message, thereby displaying only a portion of the message at any given time to the recipient by the recipient's client device to prevent recording or capture of the message.

7. The method of claim 6, wherein the step of converting the message comprises the steps of converting the message into an image of the message; and generating the set of partial image by removing a series of horizontal or vertical strips from the image.

8. The method of claim 1, wherein the step of receiving the message notification comprises the step of receiving a code to view the message on the server by the recipient using the recipient's client device.

9. The method of claim 1, further comprising the steps of transmitting a delete notification to delete the message to the server when the message is displayed by the recipient's client device; and deleting the message from the recipient's client device after a predetermined period of time.

10. The method of claim 1, further comprising the steps of deleting the message from the server after a predetermined time; and transmitting by the server the delete notification to all client devices with a copy of the message.

11. System for securely transmitting information over a communications network, comprising:
a plurality of processor based client devices for sending and receiving messages over the communications network, each client device is network enabled, associated with a user and comprises a screen to compose and display messages;
a processor based server for receiving and storing messages from the plurality of client devices in a storage device, and transmitting a message notification to a client device associated with a recipient of each message; and
wherein the client device associated with the recipient or the recipient's client device accesses the server to view the message, renders and displays the message in accordance with a display method selected by a sender of the message to present only a portion of the message at any given time on the screen to the recipient, thereby preventing recording or capture of the message.

12. System of claim 11, wherein the recipient's client device retrieves the message with a message cover; displays the message with the message cover on the screen, the message cover entirely obscuring the message from being viewed by the recipient; displays a hole having a predetermined shape and size in the message cover, within proximity of an area of the screen tapped or clicked by the recipient, to reveal the portion of the message underneath the hole, thereby preventing others in proximity of the recipient from viewing the message displayed on the screen.

13. System of claim 12, wherein the recipient's client device moves the hole to reveal a different portion of the message in response to a different area of the screen tapped or clicked by the recipient.

14. System of claim 12, wherein the recipient's client device closes the hole to entirely obscure the message when the area of the screen tapped or clicked is released by the recipient.

15. System of claim 12, wherein the recipient's client device closes the hole to entirely obscure the message after predetermined period of time.

16. System of claim 11, wherein the server converts the message into a set of partial images when the recipient's client device access the server to view the message, each partial image containing a portion of the message, generates a movie representative of the message by using the partial images as an individual movie frames, stores the partial images and the movie in the storage device, and transmits the movie representative of the message to the recipient's client device, each individual frame representing a portion of the message; and
wherein the recipient's client device displays each individual frame of the movie on the screen so that only a portion of the message is presented at any given time to the recipient to prevent recording or capture of the message.

17. A non-transitory computer readable medium comprising computer executable code for securely transmitting information over a communications network, said computer executable code comprising instructions for:
receiving a message notification that a recipient has a message on a recipient's client device from a processor based server upon receipt and storage of the message from a sender's client device in a storage device by the server over the communications network;
accessing the server to view the message by the recipient using the recipient's client device over the communications network; and
rendering and displaying the message on the recipient's client device in accordance with a display method selected by a sender of the message to present only a portion of the message at any given time to the recipient, thereby preventing recording or capture of the message.

18. The computer readable medium of claim 17, wherein said computer executable code further comprises instructions for:
retrieving from the server, the message with a message cover to entirely obscure the message when displayed by the recipient client device;
displaying the message cover on a screen of the recipient's client device which entirely obscures the message; and
displaying a hole having a predetermined shape and size in the message cover, within proximity of an area of the screen tapped or clicked by the recipient, to reveal the portion of the message underneath the hole, thereby preventing others in proximity of the recipient from viewing the message displayed on the recipient's client device.

19. The computer readable medium of claim 17, wherein said computer executable code further comprises instructions for:
converting the message into a set of partial images by the server, each partial image containing a portion of the message, when the recipient's client device access the server to view the message;
generating a movie representative of the message by the server using the partial images as an individual movie frames;
storing the partial images and the movie in the storage device by the server; and
transmitting the movie representative of the message to the recipient's client device, each individual frame of the movie representing a portion of the message, thereby displaying only a portion of the message at any given time to the recipient by the recipient's client device to prevent recording or capture of the message.

20. The computer readable medium of claim 19, wherein said computer executable code further comprises instructions for converting the message into an image of the message; and generating the set of partial image by removing a series of horizontal or vertical strips from the image.
